(19) United States
(12) Patent Application Publication
(10) Pub. No.: US 2026/0113282 A1
(43) Pub. Date: Apr. 23, 2026

(54) PROXY APPARATUS FOR SUPPORTING MULTI-ACCESS CONNECTION AND OPERATION METHOD THEREFOR

(71) Applicants: Samsung Electronics Co., Ltd., Suwon-si, Gyeonggi-do (KR); Korea Advanced Institute of Science and Technology, Daejeon (KR)

(72) Inventors: Younggyoun MOON, Suwon-si (KR); Duckwoo KIM, Daejeon (KR); Kyoungsoo PARK, Daejeon (KR)

(21) Appl. No.: 19/116,957

(22) PCT Filed: Sep. 30, 2022
(86) PCT No.: PCT/KR2022/014841

§ 371 Date: Mar. 28, 2025

(51) Int. Cl. H04L 47/34; H04L 47/19

(52) U.S. Cl. CPC H04L 47/34; H04L 47/19

(57) ABSTRACT

The present disclosure relates to 5G or 6G communication systems for supporting higher data transmission rates than 4G communication systems such as Long-Term Evolution (LTE). According to an embodiment of the present disclosure, a proxy device for supporting a multi-access connection may generate a first connection between a client and the proxy device, and a second connection between the proxy device and a server, receive first data packets from the client via at least one subflow constituting the first connection, obtain, based on at least one piece of subflow identification information included in a header of the first data packets, at least one piece of sequence identification information corresponding to the at least one piece of subflow identification information, generate a second data packet consisting of a header including the at least one piece of sequence identification information, and a payload of the first data packets, and transmit the second data packet to the server via the second connection.

### TECHNICAL FIELD

The present disclosure relates to a proxy device capable of relaying between a client and a server, and a method of operating the proxy device, and more particularly, to a proxy device for supporting a multi-access connection, and a method of operating the proxy device.

### BACKGROUND ART

A review of the development of mobile communication from generation to generation shows that the development has mostly been directed to technologies for services targeting humans, such as voice-based services, multimedia services, or data services. It is expected that connected devices, which are experiencing explosive growth after commercialization of 5^{th} generation (5G) communication systems, will be connected to communication networks. Examples of objects connected to networks may include vehicles, robots, drones, home appliances, displays, smart sensors installed in various infrastructures, construction machinery, and factory equipment. Mobile devices are expected to evolve into various form factors, such as augmented reality glasses, virtual reality headsets, or hologram devices. In the 6^{th} Generation (6G) era, efforts are underway to develop improved 6G communication systems to provide various services by connecting hundreds of billions of devices and objects. For this reason, 6G communication systems are referred to as Beyond-5G systems.

6G communication systems, which are expected to be implemented approximately by year 2030, will have a maximum transmission rate of tera (i.e., 1,000 giga)-level bps and a wireless latency of 100 microseconds (μsec). That is, the transmission rate in 6G communication systems is 50 times faster than that of 5G communication systems, and the wireless latency is reduced to one-tenth.

In order to accomplish such a high data transmission rate and an ultra-low latency, it has been considered to implement 6G communication systems in a terahertz band (e.g., the 95 GHz to 3 THz band). In the terahertz band, compared to the millimeter wave (mmWave) band introduced in 5G, the importance of technology capable of securing signal reach, i.e., coverage, is expected to increase due to more severe path loss and atmospheric absorption phenomena. It is necessary to develop, as major techniques for securing coverage, multi-antenna transmission techniques, such as new waveform, beamforming, massive multiple-input and multiple-output (MIMO), full dimensional MIMO (FD-MIMO), array antenna, or large-scale antenna, which exhibit better coverage characteristics than radio-frequency (RF) devices and orthogonal frequency-division multiplexing (OFDM). In addition, there has been an ongoing discussion on new techniques for improving the coverage of terahertz-band signals, such as metamaterial-based lenses and antennas, high-dimensional spatial multiplexing technology using orbital angular momentum (OAM), or reconfigurable intelligent surface (RIS).

Moreover, in order to improve the frequency efficiencies and system networks, the following technologies have been developed for 6G communication systems: a full duplex technology for enabling an uplink and a downlink to use the same frequency resource at the same time; a network technology for utilizing satellites, high-altitude platform stations (HAPS), and the like in an integrated manner; a network structure innovation technology for supporting mobile base stations and the like and enabling network operation optimization and automation and the like; a dynamic spectrum sharing technology though collision avoidance based on spectrum use prediction, an artificial intelligence (AI)-based communication technology for implementing system optimization by using AI from the design phase and internalizing end-to-end AI support functions; and a next-generation distributed computing technology for implementing a service having a complexity that exceeds the limit of terminal computing ability by using super-high-performance communication and computing resources (mobile edge computing (MEC), clouds, and the like). In addition, attempts have been continuously made to further enhance connectivity between devices, further optimize networks, promote software implementation of network entities, and increase the openness of wireless communication through design of new protocols to be used in 6G communication systems, development of mechanisms for implementation of hardware-based security environments and secure use of data, and development of technologies for privacy maintenance methods.

It is expected that such research and development of 6G communication systems will enable the next hyper-connected experience in new dimensions through the hyper-connectivity of 6G communication systems that covers both connections between objects and connections between humans and objects. In detail, it is expected that services such as truly immersive extended reality (XR), high-fidelity mobile holograms, and digital replicas could be provided through 6G communication systems. In addition, with enhanced security and reliability, services such as remote surgery, industrial automation, and emergency response will be provided through 6G communication systems, and thus these services will be applied to various fields including industrial, medical, automobile, and home appliance fields.

### DISCLOSURE OF INVENTION

### Technical Problem

The present disclosure relates to a proxy device for supporting a multi-access connection, and a method of operating the proxy device, in which the performance of a proxy is enhanced.

### Solution to Problem

According to an embodiment, a method of operating a proxy device may include generating a first connection between a client and a proxy device, and a second connection between the proxy device and a server. According to an embodiment, the method of operating a proxy device may include receiving first data packets from the client via at least one subflow constituting the first connection. According to an embodiment, the method of operating a proxy device may include obtaining, based on at least one piece of subflow identification information included in a header of the first data packets, at least one piece of sequence identification information corresponding to the at least one piece of subflow identification information. According to an embodiment, the method of operating a proxy device may include generating a second data packet consisting of a header including the at least one piece of sequence identification information, and a payload of the first data packets. According to an embodiment, the method of operating a proxy device may include transmitting the second data packet to the server via the second connection.

According to an embodiment, a method of operating a proxy device may include generating a first connection between a client and a proxy device, and a second connection between the proxy device and a server. According to an embodiment, the method of operating a proxy device may include receiving a third data packet from the server via the second connection. According to an embodiment, the method of operating a proxy device may include obtaining, based on at least one piece of sequence identification information included in a header of the received third data packet, at least one piece of subflow identification information corresponding to the at least one piece of sequence identification information. According to an embodiment, the method of operating a proxy device may include generating a fourth data packet consisting of a header including the at least one piece of subflow identification information, and a payload of the third data packet. According to an embodiment, the method of operating a proxy device may include transmitting the fourth data packet to the client via at least one subflow constituting the first connection.

According to an embodiment, a proxy device may include a transceiver and a processor connected to the transceiver. The processor may be configured to generate a first connection between a client and the proxy device, and a second connection between the proxy device and a server. The processor may be configured to receive a third data packet from the server via the second connection. The processor may be configured to obtain, based on at least one piece of sequence identification information included in a header of the third data packet, at least one piece of subflow identification information corresponding to the at least one piece of sequence identification information. The processor may be configured to generate a fourth data packet consisting of a header including the at least one piece of subflow identification information, and a payload of the third data packet. The processor may be configured to transmit the fourth data packet to the client via at least one subflow constituting the first connection.

According to an embodiment, a proxy device may include a transceiver and a processor connected to the transceiver. The processor may be configured to generate a first connection between a client and the proxy device, and a second connection between the proxy device and a server. The processor may be configured to receive first data packets from the client via at least one subflow constituting the first connection. The processor may be configured to obtain, based on at least one piece of subflow identification information included in a header of the first data packets, at least one piece of sequence identification information corresponding to the at least one piece of subflow identification information. The processor may be configured to generate a second data packet consisting of a header including the at least one piece of sequence identification information, and a payload of the first data packets, and transmit the second data packet to the server via the second connection.

A computer-readable recording medium disclosed as a technical unit for achieving the above-described technical objectives may have recorded thereon a program for causing a computer to execute at least one of embodiments of the disclosed method.

Other technical features may become readily apparent to those of skill in the art from the following drawings, descriptions, and claims.

### BRIEF DESCRIPTION OF DRAWINGS

FIG. 1 is a diagram for describing a proxy system according to an embodiment.

FIG. 2 is a flowchart for describing a method of performing upload data packet forwarding, according to an embodiment.

FIG. 3 is a diagram for describing a method of performing upload data packet forwarding, according to an embodiment.

FIG. 4 is a diagram for describing a method of performing out-of-order upload data packet forwarding, according to an embodiment.

FIG. 5 is a diagram for describing a method of generating a single abstract connection by using two sockets, according to an embodiment.

FIG. 6 is a diagram for describing a method of generating a single abstract connection by using a proxy socket, according to an embodiment.

FIG. 7 is a flowchart for describing a method of performing download data packet forwarding, according to an embodiment.

FIG. 8 is a diagram for describing a method of performing download data packet forwarding, according to an embodiment.

FIG. 9 is a diagram for describing a method of performing out-of-order download data packet forwarding, according to an embodiment.

FIG. 10 is a block diagram of a proxy device according to an embodiment.

### MODE FOR THE INVENTION

As the present disclosure allows for various changes and numerous embodiments, particular embodiments will be illustrated in the drawings and described in detail. However, this is not intended to limit the present disclosure to modes of practice, and it should be understood that all changes, equivalents, and substitutes that do not depart from the spirit and technical scope of the present disclosure are encompassed in the present disclosure.

In a description of an embodiment, a detailed description of relevant well-known techniques will be omitted when it unnecessarily obscures the gist of the present disclosure. In addition, ordinal numerals (e.g., ‘first’ or ‘second’) used in the description of the specification are identifier codes for distinguishing one component from another.

In addition, in the present specification, it should be understood that when components are “connected” or “coupled” to each other, the components may be directly connected or coupled to each other, but may alternatively be connected or coupled to each other with a component therebetween, unless specified otherwise.

Also, as used herein, a component expressed as, for example, ‘ . . . er (or)’, ‘ . . . unit’, ‘ . . . module’, or the like, may denote a unit in which two or more components are combined into one component or one component is divided into two or more components according to its function. In addition, each component to be described below may additionally perform, in addition to its primary function, some or all of functions of other components take charge of, and some functions among primary functions of the respective components may be exclusively performed by other components.

In addition, in the present specification, ‘upload’ should be understood as a situation in which data is transferred from a client to a server via a proxy device. On the contrary, ‘download’ should be understood as a situation in which data is transferred from a server to a client via a proxy device.

Recently, as the Internet environment has become more complex, path diversity in data transmission environments has also increased, and the 3rd Generation Partnership Project (3GPP) has defined Access Traffic Steering, Switching, and Splitting (ATSSS) in Release 16, for efficient management of access traffic that may be delivered through multiple access networks. A client that supports an ATSSS function may perform network communication by using both 3GPP and non-3GPP, and may be optionally connected to a core network with Multi-path Transmission Control Protocol (TCP) (MPTCP).

MPTCP is an extended version of TCP, and to maximize performance by making good use of multiple paths, it may utilize all available paths simultaneously during data transmission. An MPTCP session may transmit and receive data via one or more TCP subflows.

A proxy device performs communication by relaying between a client and a server, and may execute an application that allows a client to indirectly access other network services via the proxy device.

In a proxy system, a connection between a client and proxy or between a proxy and a server may be configured as only a single access connection, such as TCP-TCP, may include a multi-access connection such as MPTCP or User Datagram Protocol (UDP), or may include an access connection that supports an ATSSS function.

When receiving data transmitted from any one of a client or a server and performing data forwarding to the opposite side, a related-art proxy device generates/establishes two independent, physical connections: one between the client and the proxy and one between the proxy and the server.

Thus, when performing data forwarding, the related-art proxy device performs a process of moving data received from one side to a receive buffer, moving data to be forwarded, to a write buffer of the opposite connection, and rearranging the data into a new data packet. At this time, overhead is added, causing an issue in which the performance of the proxy device is degraded.

Embodiments of the present disclosure are to provide a proxy device for supporting a multi-access connection, and a method of operating the proxy device.

According to embodiments of the present disclosure, when performing bidirectional data forwarding in a proxy device that relays a multi-access connection between a client and a server, the performance of the proxy device may be enhanced by abstracting connections between the client and the server into a single connection and converting only the header of a data packet so as to perform data forwarding.

Hereinafter, embodiments of the present disclosure will be described in detail with reference to the accompanying drawings to allow those of skill in the art to easily carry out the embodiments. The present disclosure may, however, be embodied in many different forms and should not be construed as being limited to an embodiment set forth herein.

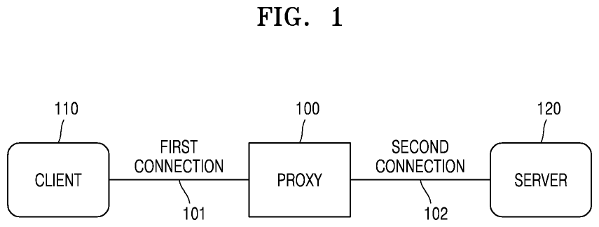

FIG. 1 is a diagram for describing a proxy system according to an embodiment.

Referring to FIG. 1, in a proxy system, a proxy device 100 relays between a client 110 and a server 120. A first connection 101 refers to a connection between the client 110 and the proxy device 100, and a second connection 102 refers to a connection between the proxy device 100 and the server 120.

The first connection 101 or the second connection 102 may be a single connection or a multi-access connection supported by a 5G/6G wireless network, may include both 3GPP access and non-3GPP access, and may be, for example, any one of TCP, MPTCP, and UDP. In a case in which the first connection 101 or the second connection 102 is a multi-access connection, each sub-connection constituting the multi-access connection is referred to as a subflow.

Hereinafter, for convenience of description, operations of the present disclosure will be described herein by taking an MPTCP-TCP proxy device for implementing an ATSSS function inside a 5G core in a 5G/6G wireless network, as an example. For example, the first connection may be an MPTCP connection, and its lower layer may consist of one or more TCP subflows. Thus, the client 110 may divide all data packets among the respective TCP subflows of MPTCP and then transmit the data packets simultaneously. The second connection may be configured as a single TCP connection.

In the present disclosure, the data packet may be a TCP packet, and an acknowledgment (ACK) may refer to a signal that may be used to confirm the arrival of a packet in a TCP connection. An ACK may typically be in a separate TCP packet format.

In the proxy system according to an embodiment, the proxy device 100 may define a mapping relationship between subflows constituting MPTCP, which is the first connection 101, and a single TCP connection, which is the second connection 102, and input information about the defined mapping relationship into the header of a TCP packet, thereby efficiently support an N:1 connection without changing the payload of the TCP packet to be forwarded.

In detail, compared to a related-art nginx proxy or dante proxy, the proxy system according to an embodiment of the present disclosure may improve throughput by 2.9 to 3.5 times or more, and may also improve latency performance by 2 to 3 times or more.

However, the technical spirit of the present disclosure is not limited to the above example, and may be applied and extended to proxy systems that support a multi-access connection according to other standards (e.g., TCP-MPTCP proxies, MPTCP-MPTCP proxies, or UDP-TCP proxies).

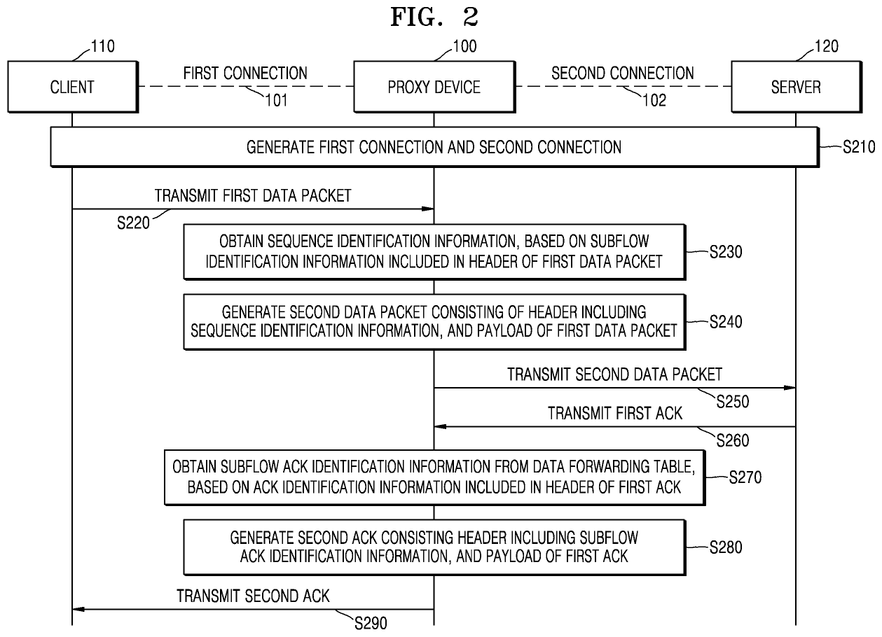

FIG. 2 is a flowchart for describing a method of performing upload data packet forwarding, according to an embodiment.

In operation S210, the proxy device 100 may generate the first connection 101 between the client 110 and the proxy device 100, and the second connection 102 between the proxy device 100 and the server 120.

In an embodiment, the proxy device 100 may generate the first connection 101 and the second connection 102 as independent connections, respectively. For example, the proxy device 100 may generate the first connection 101 by handshaking with the client 110 through a first socket, and generate the second connection 102 by handshaking with the server 120 through a second socket, respectively and independently. In this case, the proxy device 100 may perform data forwarding based on information that is independently configured for each of the first connection 101 and the second connection 102 in an application layer.

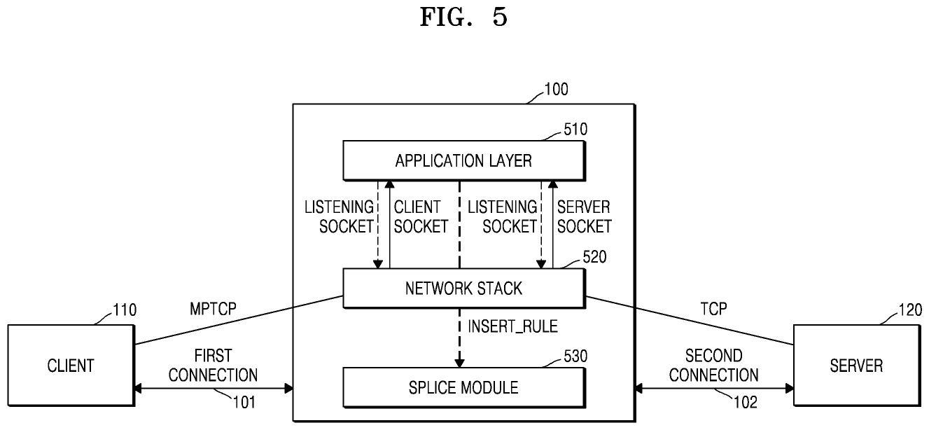

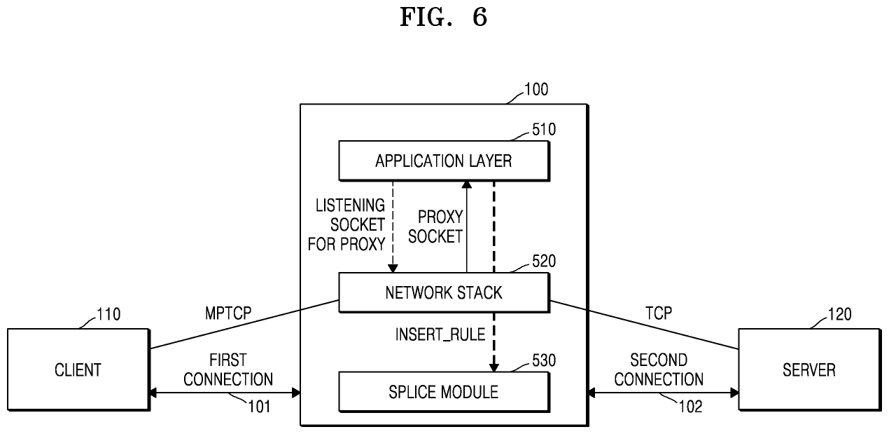

In an embodiment, the first connection 101 and the second connection 102 may constitute part of a single abstract connection generated by the proxy device 100. Here, the single abstract connection refers to a logical connection between the client 110 and the server 120, which is configured by the proxy device 100 for data forwarding. In the present disclosure, a method, performed by the proxy device 100, of generating a single abstract connection will be described with reference to FIG. 5 or 6.

In operation S220, the proxy device 100 may receive a first data packet from the client 110 via at least one subflow constituting the first connection 101. The proxy device 100 may simultaneously receive multiple TCP packets, including the first data packet, from the client 110 via one or more subflows of MPTCP. At this time, which subflow among the subflows constituting the first connection 101 the client 110 is to transmit the first data packet via may be determined based on information configured in the application layer.

In operation S230, the proxy device 100 may obtain sequence identification information corresponding to each subflow identification information, based on subflow identification information included in the header of the first data packet.

In a case in which the core network in the 5G/6G wireless network supports the ATSSS function and the client 110 supports the ATSSS function, an MPTCP option may be included in an option field of the header of the TCP packet. In this case, the TCP header may include a subflow identifier (id), a subflow sequence number, and a data sequence number.

The subflow id is information about which subflow among the subflows of MPTCP the packet is to be transmitted via. The subflow sequence number is information about the position of the corresponding packet within the subflow. The data sequence number is information about the position of the corresponding packet within the entire data sequence transmitted by the client or the server to the proxy device 100.

The proxy device 100 may read the header of the TCP packet received from the client 110 to obtain subflow identification information including a subflow id, a subflow sequence number, and a client data sequence number that are included in the header. Here, the client data sequence number is information about the position of the corresponding packet within the entire data sequence received by the proxy device 100 from the client 110.

The proxy device 100 may map the obtained subflow id and subflow sequence number according to the order of obtained client data sequence numbers.

The proxy device 100 may add a predetermined offset to the mapped client data sequence number to convert it to a server data sequence number, and obtain sequence identification information including the server data sequence number. Here, the server data sequence number is information about the position of the corresponding packet within the entire data sequence transmitted by the proxy device 100 to the server 120.

In an embodiment, the proxy device 100 may store, in a data forwarding table, mapping information between the subflow identification information and the sequence identification information.

In operation S240, the proxy device 100 may generate a second data packet consisting of a header including the sequence identification information, and the payload of the first data packet.

In operation S250, the proxy device 100 may transmit the second data packet to the server 120 via the second connection 102. For example, the second connection 102 may be a single TCP connection.

In operation S260, the proxy device 100 may receive, from the server 120, a first ACK for the second data packet. Here, the first ACK may be in the form of a TCP packet and may consist of a TCP header and a payload. The header of the first ACK may include ACK identification information including an ACK number. The payload of the first ACK may include information indicating that the second data packet has been successfully received.

In operation S270, the proxy device 100 may obtain subflow ACK identification information from a previously stored data forwarding table, based on the ACK identification information included in the header of the first ACK.

The proxy device 100 may read the header of the first ACK received from the server 120 to obtain ACK identification information. The ACK identification information may include the server data sequence number of the second data packet.

The proxy device 100 may search the previously stored data forwarding table based on the server data sequence number included in the obtained ACK identification information, to obtain subflow ACK identification information including a corresponding subflow id and subflow sequence number.

In operation S280, the proxy device 100 may generate a second ACK consisting a header including the subflow ACK identification information, and the payload of the first ACK.

In operation S290, the proxy device 100 may transmit the second ACK to the client 110 via at least one subflow constituting the first connection 101. Which subflow among the subflows constituting the first connection 101 the proxy device 100 is to transmit the second ACK via may be determined according to the subflow id included in the subflow ACK identification information.

According to a series of operations S210 to S290, the proxy device 100 may forward a data packet, which is received from the client 110 via the multi-access connection, to the server 120 after converting only the header without modifying the payload, thereby reducing overhead and enhancing the performance of the proxy device.

In an embodiment, the client 110 may configure a TCP timer (e.g., a retransmission timer) for at least one subflow constituting the first connection 101. The client 110 may start the retransmission timer when transmitting the first data packet via a subflow. When the second ACK is not received within a predetermined time (a retransmission timeout (RTO)), the client 110 may retransmit, to the proxy device 100, the first data packet for which the second ACK has not been received.

When there is a first data packet for which a second ACK has not been received, the proxy device 100 may receive, from the client 110, the data packet for which the second ACK has not been received. The proxy device 100 may read the header of the data packet for which the second ACK has not been received, to obtain the subflow identification information included in the header. The proxy device 100 searches the previously stored data forwarding table based on the obtained subflow identification information, to obtain sequence identification information corresponding to the obtained subflow identification information. The proxy device 100 may generate a data packet consisting of a header including the obtained sequence identification information and the payload of the data packet for which the second ACK has not been received, and transmit the data packet to the server 120.

Thus, in a proxy system including a multi-access connection, even when retransmitting data because an ACK has not been received, the proxy device 100 according to an embodiment may convert only the header of the packet by utilizing a previously stored data forwarding table and then forward the retransmitted data, thereby reducing overhead and enhancing the performance of the proxy device.

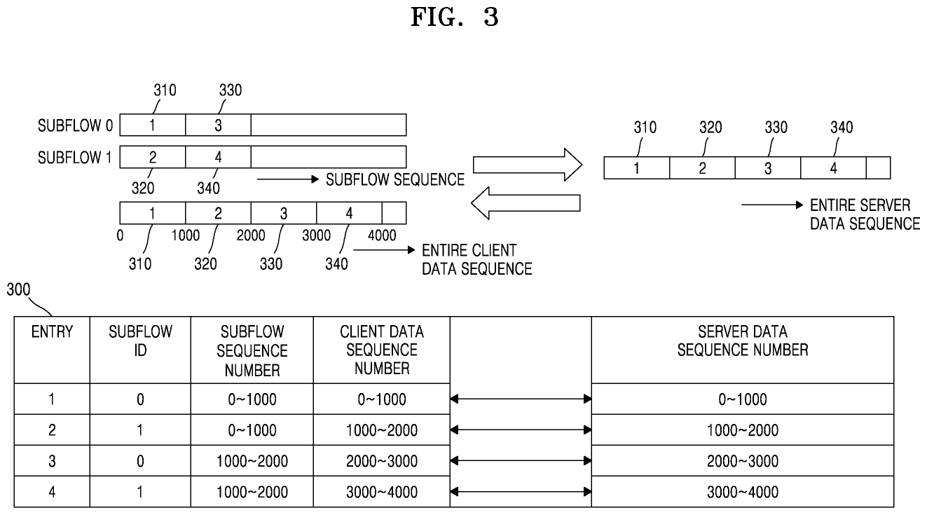

FIG. 3 is a diagram for describing a method of performing upload data packet forwarding, according to an embodiment.

Referring to FIG. 3, information about mapping relationships between subflow identification information and sequence identification information may be stored in a data forwarding table 300. In the data forwarding table 300, entries may be stored to correspond to respective data packets.

The proxy device 100 receives data packet 1 310 and data packet 3 330 via subflow 0, and receives data packet 2 320 and data packet 4 340 via subflow 1 from the client 110, simultaneously or sequentially. Subflow 0 and subflow 1 may constitute the first connection 101.

Hereinafter, description will be made based on data packet 1 310. The proxy device 100 performs the same operation for data packet 2 320, data packet 3 330, and data packet 4 340.

The proxy device 100 reads the header of data packet 1 310 to obtain subflow identification information including subflow id 0, subflow sequence numbers 0 to 1000, and client data sequence numbers 0 to 1000. The proxy device 100 maps subflow id 0 and subflow sequence numbers 0 to 1000 to client data sequence numbers 0 to 1000. In the case of data packet 3 330, subflow id 0 and subflow sequence numbers 1000 to 2000 may be mapped to client data sequence numbers 2000 to 3000.

The proxy device 100 adds a predetermined offset (here, assumed to be 0) to the mapped client data sequence numbers 0 to 1000, so as to convert them to server data sequence numbers 0 to 1000.

The proxy device 100 stores, in entry 1 of the data forwarding table 300, information about a mapping relationship among subflow id 0, subflow sequence numbers 0 to 1000, client data sequence numbers 0 to 1000, and server data sequence numbers 0 to 1000, for data packet 1 310.

The proxy device 100 generates a TCP packet consisting of a header including sequence identification information including server data sequence numbers 0 to 1000, and the payload of data packet 1 310, and transmits the TCP packet to the server 120. That is, the TCP packet, with only the header of data packet 1 310 converted, is transmitted to the server 120 via a single TCP connection.

The proxy device 100 receives a first ACK for data packet 1 310, from the server 120 via a single TCP connection. The proxy device 100 reads the header of the ACK for data packet 1 310 to obtain ACK identification information including server sequence numbers 0 to 1000.

The proxy device 100 searches the previously stored data forwarding table 300 to obtain subflow ACK identification information including subflow id 0 and subflow sequence numbers 0 to 1000, which correspond to server sequence numbers 0 to 1000, in entry 1 corresponding to data packet 1 310.

The proxy device 100 generates an ACK consisting of a header including the subflow ACK identification information including subflow id 0 and subflow sequence numbers 0 to 1000, and the payload of the ACK, and transmits the ACK to the client 110. At this time, the proxy device 100 will determine to transmit the generated ACK via subflow 0 according to subflow id 0 included in the header of the generated ACK.

The client 110 starts a retransmission timer when transmitting data packet 1 310 via subflow 0. When an ACK for data packet 1 310 is not received within a predetermined time (an RTO), the client 110 retransmits data packet 1 310 to the proxy device 100.

The proxy device 100 re-receives data packet 1 310 from the client 110. The proxy device 100 reads the header of data packet 1 310 to obtain subflow identification information including subflow id 0 and subflow sequence numbers 0 to 1000.

The proxy device 100 searches the previously stored data forwarding table to obtain sequence identification information including server data sequence numbers 0 to 1000 corresponding to subflow id 0 and subflow sequence numbers 0 to 1000.

The proxy device 100 generates a data packet consisting of a header including the sequence identification information including server data sequence numbers 0 to 1000, and the payload of data packet 1 310, and retransmits the generated data packet to the server 120.

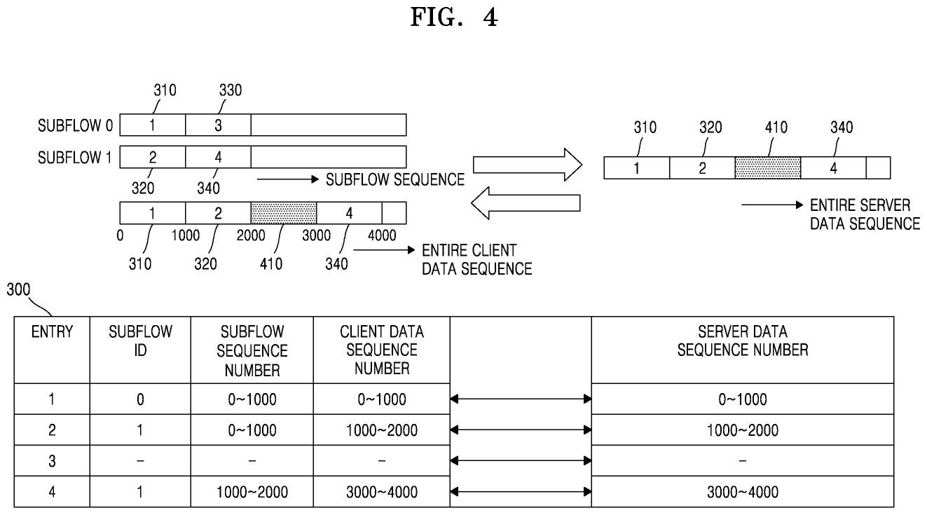

FIG. 4 is a diagram for describing a method of performing out-of-order upload data packet forwarding, according to an embodiment.

Even when the client 110 has normally transmitted multiple data packets via at least one subflow constituting the first connection 101, the proxy device 100 may receive an out-of-order data packet due to various causes (e.g., network failure).

In an embodiment, when performing operations S201 to S205, in a case in which an out-of-order data packet is included among the data packets received from the client 110, the proxy device 100 may keep the entry corresponding to the out-of-order data packet in the data forwarding table 300 as is. At this time, the proxy device 100 may set, as a blank space, the entry corresponding to a data packet that has not been received from the client 110, in the data forwarding table 300.

In an embodiment, the proxy device 100 may receive, from the server 120, a first selective ACK (SACK) for an out-of-order packet. A SACK may be transmitted and received between the client and the server when a received packet is out-of-order, and for example, it may be generated by including information in the header of an ACK, which indicates that the packet is out-of-order. The payload of the SACK may include information indicating that a particular data packet has been received by the server 120. However, this is only an example, and the SACK may be generated to have a format separate from that of an ACK.

The proxy device 100 may obtain subflow SACK identification information from a previously stored data forwarding table, based on SACK identification information included in the header of the first SACK.

The proxy device 100 may read the header of the SACK received from the server 120 to obtain the SACK identification information included in the header. The SACK identification information may include the server data sequence number of the out-of-order packet.

The proxy device 100 may search the previously stored data forwarding table based on the server data sequence number included in the obtained SACK identification information, to obtain subflow SACK identification information including a corresponding subflow id and subflow sequence number.

The proxy device 100 may generate a second SACK consisting of a header including the subflow SACK identification information, and the payload of the first SACK. When generating the second SACK, the proxy device 100 may remove, from the header of the second SACK, information indicating that the packet is an out-of-order packet, and in this case, the second SACK may be represented as an ACK. However, when generating the second SACK, the proxy device 100 may also include, in the header of the second SACK, information indicating that the packet is an out-of-order packet. A detailed example of an operation of the proxy device 100 performed in this case will be described below with reference to FIG. 4.

The proxy device 100 may transmit the second SACK to the client 110 via at least one subflow constituting the first connection 101. Which subflow among the subflows constituting the first connection 101 the proxy device 100 is to transmit the second SACK via may be determined according to a subflow id included in subflow SACK identification information.

In the related art, when out-of-order data is received by a proxy device, the proxy device waits for a preset time until the entire data sequence is filled and then performs data forwarding, leading to an issue of degraded proxy performance.

Even when out-of-order data is received from the client 110 in a proxy system including a multi-access connection, the proxy device 100 according to an embodiment of the present disclosure may convert only the header of the packet by utilizing a data forwarding table and then forward the data, thereby reducing overhead and enhancing the performance of the proxy device.

In addition, in a proxy system including a multi-access connection, the proxy device 100 according to an embodiment of the present disclosure may convert only the header of a packet by using a data forwarding table and then forward data by utilizing a SACK, thereby reducing overhead and enhancing the performance of the proxy device.

In addition, in a proxy system including a multi-access connection, the proxy device 100 according to an embodiment of the present disclosure may convert only the header of a packet by using a data forwarding table and then forward data by utilizing a negative ACK (NACK), thereby reducing overhead and enhancing the performance of the proxy device.

Referring to FIG. 4, the client 110 transmits data packet 1 310 and data packet 3 330 to the proxy device 100 via subflow 0, and transmits data packet 2 320 and data packet 4 340 via subflow 1.

Due to various causes (e.g., network failure), among data packets transmitted by the client 110, data packet 3 330 may not be received by the proxy device 100 or may be received with a delay.

In this case, data packet 3 330 corresponds to a data packet 410 that has not been received from the client 110, and data packet 4 340 corresponds to an out-of-order data packet.

The header of data packet 4 340 includes subflow identification information, that is, subflow id 1, subflow sequence numbers 1000 to 2000, and client data sequence numbers 3000 to 4000.

Thereafter, the proxy device 100 performs operations S210 to S250 for data packet 1 310, data packet 2 320, and data packet 4 340. The proxy device 100 keeps entry 4 corresponding to data packet 4 340 as is, in the data forwarding table 300. At this time, the proxy device 100 sets, as a blank space, entry 3 corresponding to data packet 3 330, which is the data packet 410 that has not been received from the client 110).

The proxy device 100 receives, from the server 120, ACKs for data packet 1 310 and data packet 2 320, and in this case, the proxy device 100 performs operations S260 to S290.

The proxy device 100 receives, from the server 120, a sack for data packet 4 340, which is an out-of-order packet.

The proxy device 100 reads the header of the SACK to obtain SACK identification information including server data sequence numbers 3000 to 4000 of data packet 4 340.

The proxy device 100 searches the previously stored data forwarding table 300 to obtain subflow SACK identification information including subflow id 1 and subflow sequence numbers 1000 to 2000, which correspond to server data sequence numbers 3000 to 4000, in entry 4 corresponding to data packet 4 340.

The proxy device 100 generates a SACK consisting of a header including the subflow SACK identification information including subflow id 1 and subflow sequence numbers 1000 to 2000, and the payload of the SACK, and transmits the SACK to the client 110. The proxy device 100 will determine to transmit the generated SACK via subflow 1 according to subflow id 1 included in the header of the generated SACK. Here, when generating the SACK, the proxy device 100 may remove, from the header of the SACK, information indicating that the packet is an out-of-order data packet, and in this case, the SACK may be represented as an ACK.

When data packet 4 340 is received via subflow 0 and the header of data packet 4 340 includes subflow id 0 and subflow sequence numbers 2000 to 3000, the proxy device 100 generates a SACK consisting of a header including subflow id 0 and subflow sequence numbers 2000 to 3000, and the payload of the SACK, and transmits the generated SACK to the client 110. In this case, when generating the SACK, the proxy device 100 includes, in the header of the SACK, information indicating that the packet is an out-of-order data packet, rather than removing it.

In an embodiment, the proxy device 100 may receive, from the server 120, a NACK for a data packet that has not been received by the server 120. A NACK may typically be in a separate TCP packet format. A NACK may be referred to as a NAK and may refer to a signal that may be used to confirm the arrival of a packet in a TCP connection. The header of a NACK may include sequence identification information about a data packet that has not been received by the server 120, and the payload of the NACK may include information indicating that a particular data packet has not been successfully received by the server 120.

The proxy device 100 may perform forwarding to the client 110 after converting only the header of the NACK. The client 110 that has received the NACK may retransmit, to the proxy device 100, the data packet that has not been received by the server 120. The proxy device 100 may forward the re-received data packet to the server 120 after converting only the header according to operations S201 to S205.

Referring to FIG. 4,
the proxy device 100 may receive, from the server 120, a NACK for data packet 3 330, i.e., the packet 410 that has not been received from the client 110, and forward the received NACK to the client 110. The proxy device 100 may modify the header of the NACK received from the server 120 and then forward the NACK to the client 110, and the detailed operations for this process may correspond to the method of forwarding an ACK described above with reference to FIG. 3. The NACK includes server data sequence numbers 2000 to 3000 of data packet 3 330. The client 110 that has received the NACK may retransmit data packet 3 330 to the proxy device 100.

FIG. 5 is a diagram for describing a method of generating a single abstract connection by using two sockets, according to an embodiment.

Referring to FIG. 5, in a proxy system, the proxy device 100 relays between the client 110 and the server 120. The first connection 101 refers to a connection between the client 110 and the proxy device 100, and the second connection 102 refers to a connection between the proxy device 100 and the server 120.

Hereinafter, for convenience of description, operations of the present disclosure will be described herein by taking an MPTCP-TCP proxy device for implementing an ATSSS function inside a 5G core in a 5G/6G wireless network, as an example.

In an embodiment, the proxy device 100 may include an application layer 510, a network stack 520, and a splice module 530.

The application layer 510 may refer to a layer that provides a user interface for various sub-communication protocol entities in a TCP/IP protocol layer model.

The network stack 520 may include all lower layers of the application layer, such as a TCP/IP layer.

The splice module 530 may include a network interface card (NIC) that transmits and receives data packets. The splice module 530 may be included in a processor 1020 or a memory 1030 in the proxy device 100, which will be described below, and may also be implemented as software in the application layer 510 and the network stack 520.

In an embodiment, the first connection 101 and the second connection 102 may constitute a single abstract connection. Here, the single abstract connection refers to a logical connection between the client 110 and the server 120, which is configured by the proxy device 100 for data forwarding.

In an embodiment, the proxy device 100 may generate a single abstract connection in the application layer 510 by using a client socket and a server socket, through an insert_fwd_rule( ) function configured for a single abstract connection. The application layer 510 may manage the configuration for the generated single abstract connection, to support an ATSSS function in the proxy system. Here, the client socket may include all sockets of the client 110 used to generate a TCP connection, or packets (e.g., SYN, ACK, or FIN) transmitted through a socket for handshaking. In addition, the server socket may include all sockets of the server 120 used to generate a TCP connection, or packets (e.g., SYN, ACK, or FIN) transmitted through a socket for handshaking.

In the network stack 520, the proxy device 100 may receive a client socket from the client 110 via subflows constituting an MPTCP connection, and may receive a server socket from the server 120 via a TCP connection. At this time, the proxy device 100 may specify an MPTCP socket option by using a setsockopt( ) function in a socket application programming interface (API), so as to operate in an MPTCP-TCP proxy system. The setsockopt( ) function is a function used to change socket configuration values in the socket API.

Based on the socket API, the proxy device 100 may perform handshaking for each of two sockets in the network stack 520 to generate two independent connections. The proxy device 100 may deliver the two sockets to the application layer 510.

In the application layer 510, to abstract the two independent connections into a single connection, the proxy device 100 may activate an insert_fwd_rule (socket_from, socket_to) function to specify a client socket or a server socket in the socket_from parameter and the socket_to parameter. Here, the insert_fwd_rule( ) function may be used in the socket API used in the application layer, and the names of the function and parameters are only examples and are not limited to the above example.

The proxy device 100 may perform the above-described operations for each of multiple subflows constituting an MPTCP connection.

The proxy device 100 may deliver, to the splice module 530 via the network stack 520, information about various configurations including the insert_fwd_rule( ) function configured for a single abstract connection in the application layer 510.

Based on the information configured for a single abstract connection in the application layer 510, the proxy device 100 may forward, to the server 120, a data packet received from the client 110 through the splice module 530 via the MPTCP connection, after converting only the header. In addition, on the contrary, based on the information configured for a single abstract connection in the application layer 510, the proxy device 100 may forward, to the client 110 via an MPTCP connection, a data packet received from the server 120 through the splice module 530, after converting only the header.

FIG. 6 is a diagram for describing a method of generating a single abstract connection by using a proxy socket, according to an embodiment.

In an embodiment, the proxy device 100 may generate a single abstract connection in the application layer 510 by using a proxy socket configured for a single abstract connection. The application layer 510 may manage the configuration for the generated single abstract connection, to support an ATSSS function in the proxy system.

The proxy device 100 may generate a listening socket for a proxy in the application layer 510. The listening socket for a proxy may wait for a proxy socket that participates in generation of a single abstract connection.

The proxy device 100 may receive a client socket from the client 110 via subflows constituting an MPTCP connection, in the network stack 520. The proxy device 100 may transmit the received client socket directly to the server 120 via a TCP connection. That is, the proxy device 100 may serve as a broker between the client 110 and the server 120, thereby performing handshaking to generate a single abstract connection and a proxy socket for the single abstract connection.

The proxy device 100 may generate a proxy socket through a socket (int domain, int type, int protocol) function. Socket( ) is a function for generating a socket in the socket API, int domain is a parameter that specifies a domain in which communication is to be performed, int type is a parameter that specifies the type of protocol to be used, and int protocol is a parameter that determines a protocol value. For example, the proxy device 100 may generate a proxy socket by using socket(AF_INET, SOCK_PROXY, IPPROTO_MPTCP). The SOCK_PROXY option may refer to an option for generating a socket for a proxy. AF_INET indicates performing communication in the Internet Protocol version 6 (IPv6) domain, and IPPROTO_MPTCP indicates a declaration of support for MPTCP.

Thereafter, in the case of other subflows constituting the MPTCP connection, the proxy device 100 may generate a single abstract connection between the client 110 and the server 120 by performing handshaking between the client 110 and the proxy device 100.

The proxy device 100 may deliver information about the single abstract connection configured in the application layer 510, to the splice module 530 via the network stack 520.

Based on the information configured for a single abstract connection in the application layer 510, the proxy device 100 may forward, to the server 120, a data packet received from the client 110 through the splice module 530 via the MPTCP connection, after converting only the header. In addition, on the contrary, based on the information configured for a single abstract connection in the application layer 510, the proxy device 100 may forward, to the client 110 via an MPTCP connection, a data packet received from the server 120 through the splice module 530, after converting only the header.

The proxy device 100 may extend and apply the socket API in the application layer 510 to change the configuration for the single abstract connection generated by the proxy device 100 or to obtain the configuration values.

The proxy device 100 may extend the int level parameter in setsockopt( ) to use the SOL_CLI_SIDE parameter. The setsockopt( ) function is a function used to change socket configuration values in the socket API. Int level declares the level of socket information to be changed. The proxy device 100 may change the forwarding policy of ATSSS or the address value of a subflow in the MPTCP connection on the side of the client 110 by using the SOL_CLI_SIDE parameter.

The proxy device 100 may extend the int level parameter in getsockopt( ) to use the SOL_PROXY parameter. The getsockopt( ) function is a function used to obtain the current socket configuration values in the socket API. The proxy device 100 may obtain the configuration values for a single abstract connection by using the SOL_PROXY parameter. For example, the configuration values for a single abstract connection may include an interrupt mode or a splice mode. In the interrupt mode, the proxy device 100 may configure the application layer 510 to, when data forwarding occurs in the splice module 530, read the payload of a data packet. In the splice mode, the proxy device 100 may configure the application layer 510 to, when data forwarding occurs in the splice module 530, read only information indicating that data forwarding has occurred, rather than reading the payload of a data packet.

The proxy device 100 may activate a getsockstat( ) function. The getsockstat( ) function may be defined to perform functions similar to read( ) and write( ) functions in the socket API. By activating the getsockstat( ) function, in the splice mode, the proxy device 100 may obtain information including the total number of forwarded data bytes, statistics for a current MPTCP session, or statistics for subflows.

When receiving data transmitted from any one of a client or a server and performing data forwarding to the opposite side, a related-art proxy device generates two independent, physical connections, including one between the client and the proxy, and one between the proxy and the server, manages the two connections respectively, and forwards data.

Thus, when performing data forwarding, the related-art proxy device performs a process of moving data received from one side to a receive buffer, moving data to be forwarded, to a write buffer of the opposite connection, and rearranging the data into a new data packet. At this time, overhead is added, causing an issue in which the performance of the proxy device is degraded.

According to embodiments of the present disclosure, when performing bidirectional data forwarding in a proxy device that relays a multi-access connection between a client and a server, the performance of the proxy device may be enhanced by abstracting connections between the client and the server into a single connection and converting only the header of a data packet so as to perform data forwarding.

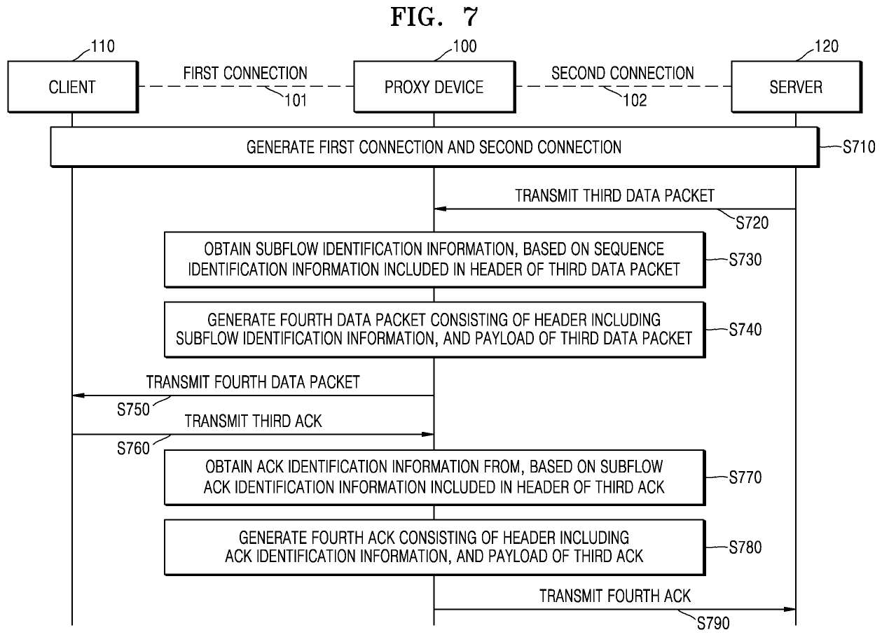

FIG. 7 is a flowchart for describing a method of performing download data packet forwarding, according to an embodiment.

In operation S710, the proxy device 100 may generate the first connection 101 between the client 110 and the proxy device 100, and the second connection 102 between the proxy device 100 and the server 120.

In an embodiment, the proxy device 100 may generate the first connection 101 and the second connection 102 as independent connections, respectively. For example, the proxy device 100 may generate the first connection 101 by handshaking with the client 110 through a first socket, and generate the second connection 102 independently by handshaking with the server 120 through a second socket. In this case, the proxy device 100 may perform data forwarding based on information that is independently configured for each of the first connection 101 and the second connection 102 in an application layer.

In an embodiment, the first connection 101 and the second connection 102 may constitute part of a single abstract connection generated by the proxy device 100. Here, the single abstract connection refers to a logical connection between the client 110 and the server 120, which is configured by the proxy device 100 for data forwarding. The single abstract connection may be generated according to the method described above with reference to FIG. 5 or 6.

In operation S720, the proxy device 100 may receive a third data packet from the server 120 via the second connection 102. For example, the second connection 102 may be a single TCP connection.

In operation S730, the proxy device 100 may obtain subflow identification information corresponding to sequence identification information, based on the sequence identification information included in the header of the third data packet.

The proxy device 100 may read the header of a TCP packet received from the server 120 to obtain sequence identification information including a server data sequence number included in the header. Here, the server data sequence number is information about the position of the corresponding packet within the entire data sequence received by the proxy device 100 from the server 120.

The proxy device 100 may add a predetermined offset to the server data sequence number included in the obtained sequence identification information, so as to convert the server data sequence number to a client data sequence number. Here, the client data sequence number is information about the position of the corresponding packet within the entire data sequence transmitted by the proxy device 100 to the client 110.

Based on information configured in the application layer, the proxy device 100 maps the client data sequence number to the subflow id of each subflow constituting the first connection 101, and a subflow data sequence number. The proxy device 100 may obtain subflow identification information including a subflow id and a subflow data sequence number.

In an embodiment, the proxy device 100 may store, in a data forwarding table, information about a mapping relationship between the sequence identification information and the subflow identification information.

In operation S740, the proxy device 100 may generate a fourth data packet consisting of a header including the subflow identification information, and the payload of the third data packet.

In operation S750, the proxy device 100 may transmit the fourth data packet to the client 110 via at least one subflow constituting the first connection 101. The proxy device 100 may simultaneously transmit multiple TCP packets, including the fourth data packet, to the client 110 via one or more subflows of MPTCP. At this time, which subflow among the subflows constituting the first connection 101 the proxy device 100 is to transmit the fourth data packet via may be determined by the subflow id included in the subflow identification information.

In operation S760, the proxy device 100 may receive, from the client 110, a third ACK for the fourth data packet. Here, the third ACK may be in the form of a TCP packet and may consist of a TCP header and a payload. The header of the third ACK may include ACK identification information including an ACK number. The payload of the third ACK may include information indicating that the fourth data packet has been successfully received.

In operation S770, the proxy device 100 may obtain sequence ACK identification information from the previously stored data forwarding table, based on the subflow ACK identification information included in the header of the third ACK.

The proxy device 100 may read the header of the third ACK received from the client 110 to obtain subflow ACK identification information. The subflow ACK identification information may include a subflow id, a subflow sequence number, and a client sequence number of the fourth data packet.

The proxy device 100 may search the previously stored data forwarding table, based on the obtained subflow ACK identification information, to obtain sequence ACK identification information including the corresponding server data sequence number.

In operation S780, the proxy device 100 may generate a fourth ACK consisting of a header including the sequence ACK identification information, and the payload of the third ACK.

In operation S790, the proxy device 100 may transmit the fourth ACK to the server 120 via the second connection 102.

According to a series of operations S710 to S790, the proxy device 100 may forward, to the client 110 via a multi-access connection, a data packet received from the server 120, after converting only the header without modifying the payload, thereby reducing overhead and enhancing the performance of the proxy device.

In an embodiment, the server 120 may configure a TCP timer (e.g., a retransmission timer) for the second connection 102. The server 120 may start the retransmission timer when transmitting the third data packet. When the fourth ACK is not received within a predetermined time (an RTO), the server 120 may retransmit, to the proxy device 100, the third data packet for which the fourth ACK has not been received.

When there is a third data packet for which a fourth ACK has not been received, the proxy device 100 may receive, from the server 120, the data packet for which the fourth ACK has not been received. The proxy device 100 may read the header of the data packet for which the fourth ACK has not been received, to obtain the sequence identification information included in the header. The proxy device 100 searches the previously stored data forwarding table based on the obtained sequence identification information, to obtain subflow identification information corresponding to the obtained sequence identification information. The proxy device 100 may generate a data packet consisting of a header including the obtained subflow identification information, and the payload of the data packet for which the fourth ACK has not been received, and transmit the data packet to the client 110 via at least one subflow constituting the first connection 101.

Thus, in a proxy system including a multi-access connection, even when retransmitting data because an ACK has not been received, the proxy device 100 according to an embodiment may convert only the header of the retransmitted packet by utilizing a previously stored data forwarding table and then forward the data, thereby reducing overhead and enhancing the performance of the proxy device.

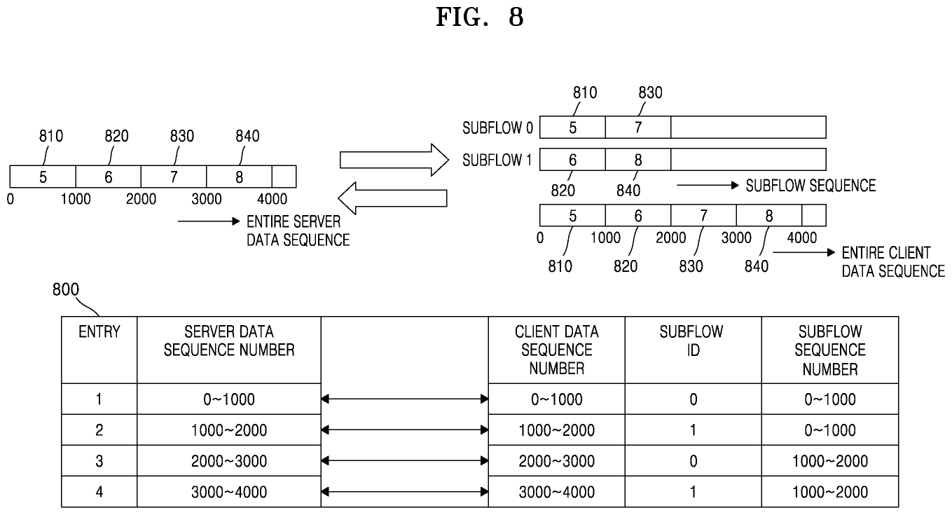

FIG. 8 is a diagram for describing a method of performing download data packet forwarding, according to an embodiment.

Referring to FIG. 8, information about a mapping relationship between sequence identification information and subflow identification information may be stored in a data forwarding table 800. In the data forwarding table 800, entries may be stored to correspond to respective data packets.

The proxy device 100 receives data packet 5 810, data packet 6 820, data packet 7 830, and data packet 8 840, from the server 120 via the first connection 101. Subflow 0 and subflow 1 may constitute the first connection 101.

Hereinafter, description will be made based on data packet 5 810. The proxy device 100 performs the same operation for data packet 6 820, data packet 7 830, and data packet 8 840.

The proxy device 100 reads the header of data packet 5 810 to obtain sequence identification information including server data sequence numbers 0 to 1000. The proxy device 100 adds a predetermined offset (here, assumed to be 0) to the server data sequence numbers 0 to 1000 included in the obtained sequence identification information, so as to convert them to client data sequence numbers 0 to 1000.

Based on information configured in the application layer, the proxy device 100 maps client data sequence numbers 0 to 1000 to subflow id 0 and subflow sequence numbers 0 to 1000. In the case of data packet 8 840, client data sequence numbers 3000 to 4000 may be mapped to subflow id 1 and subflow sequence numbers 1000 to 2000.

The proxy device 100 stores, in entry 1 of the data forwarding table 800, information about a mapping relationship among server data sequence numbers 0 to 1000, client data sequence numbers 0 to 1000, subflow id 0, and subflow sequence numbers 0 to 1000, for data packet 5 810.

The proxy device 100 generates a TCP packet consisting of a header including subflow identification information including subflow id 0, subflow sequence numbers 0 to 1000, and client data sequence numbers 0 to 1000, and the payload of data packet 5 810, and transmits the TCP packet to the client 110. That is, the TCP packet, with only the header of data packet 5 810 converted, is transmitted to the client 110 via an MPTCP connection. At this time, the proxy device 100 determines to transmit the generated TCP packet via subflow 0 according to subflow id 0 included in the header of the generated TCP packet.

The proxy device 100 receives a fourth ACK for data packet 5 810, from the client 110 via at least one subflow constituting MPTCP. The proxy device 100 reads the header of the ACK for data packet 5 810 to obtain subflow ACK identification information including client sequence numbers 0 to 1000.

The proxy device 100 searches the previously stored data forwarding table 800 to obtain ACK identification information including server data sequence numbers 0 to 1000 corresponding to client sequence numbers 0 to 1000, in entry 1 corresponding to data packet 5 810.

The proxy device 100 generates an ACK consisting of a header including the ACK identification information including server data sequence numbers 0 to 1000, and the payload of the ACK, and transmits the ACK to the server 120 via a single TCP connection.

The server 120 starts a retransmission timer when transmitting data packet 5 810. When an ACK for data packet 5 810 is not received within a predetermined time (an RTO), the server 120 retransmits data packet 5 810 to the proxy device 100.

The proxy device 100 re-receives data packet 5 810 from the server 120. The proxy device 100 reads the header of data packet 5 810 to obtain the sequence identification information including the server data sequence numbers 0 to 1000.

The proxy device 100 searches the previously stored data forwarding table to obtain subflow identification information including subflow id 0 and subflow sequence numbers 0 to 1000, which correspond to server data sequence numbers 0 to 1000.

The proxy device 100 generates a data packet consisting of a header including the subflow identification information including subflow id 0 and subflow sequence numbers 0 to 1000, and the payload of data packet 5 810, and retransmits the generated data packet to the client 110. At this time, the proxy device 100 determines to retransmit the generated data packet via subflow 0 according to subflow id 0 included in the header of the generated data packet.

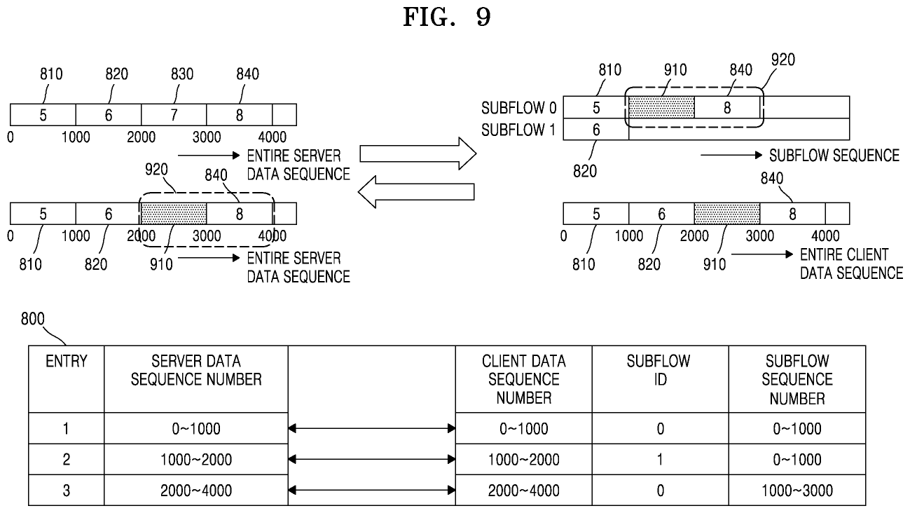

FIG. 9 is a diagram for describing a method of performing out-of-order download data packet forwarding, according to an embodiment.

Even when the server 120 has normally transmitted multiple data packets via the second connection 102, the proxy device 100 may receive an out-of-order data packet due to various causes (e.g., network failure).

In an embodiment, when performing operations S701 to S705, in a case in which an out-of-order data packet is included among the data packets received from the server 120, the proxy device 100 may keep the entry corresponding to the out-of-order data packet in the data forwarding table 800 as is. At this time, the proxy device 100 may set, as a blank space, the entry corresponding to a data packet that has not been received from the server 120, in the data forwarding table 800. In this case, the proxy device 100 may perform data forwarding for a download in the same manner as it performs data forwarding for an upload.

In an embodiment, when performing operations S701 to S705, in a case in which an out-of-order data packet is included among the data packets received from the server 120, the proxy device 100 may merge sequence identification information included in the header of the out-of-order data packet, and sequence identification information corresponding to the data packet that has not been received from the server, into one sequence identification. At this time, the proxy device 100 may set the merged sequence identification information as one entry in the data forwarding table 800.

In this case, the proxy device 100 may determine a mapping relationship of the merged sequence identification information with a subflow, based on information configured in the application layer.

In an embodiment, the proxy device 100 may receive a third SACK for an out-of-order packet, from the client 110 via at least one subflow constituting the first connection 101. The SACK may be generated by including, in the header of an ACK, information indicating that the packet is an out-of-order packet. The payload of the SACK may include information indicating that a particular data packet has been received by the client 110. However, this is only an example, and the SACK may be generated to have a format separate from that of an ACK.

The proxy device 100 may obtain ACK identification information from a previously stored data forwarding table, based on subflow SACK identification information included in the header of the third SACK.

The proxy device 100 may read the header of the third SACK received from the client 110 to obtain the subflow SACK identification information included in the header. The subflow SACK identification information may include a client data sequence number of the out-of-order packet.

The proxy device 100 may search the previously stored data forwarding table based on the client data sequence number included in the obtained subflow SACK identification information, to obtain ACK identification information including a corresponding server data sequence number.

The proxy device 100 may generate a fourth SACK consisting of a header including the ACK identification information, and the payload of the third SACK. The proxy device 100 may generate the fourth SACK by including, in the header of an ACK, information indicating that the packet is an out-of-order packet. However, when generating the fourth SACK, the proxy device 100 may remove, from the header of the ACK, the information indicating that the packet is an out-of-order packet, and in this case, the fourth SACK may be represented as an ACK.

The proxy device 100 may transmit the fourth ACK to the server 120 via the second connection 102.

In the related art, when out-of-order data is received by a proxy device, the proxy device waits for a preset time until the entire data sequence is filled and then performs data forwarding, leading to an issue of degraded proxy performance.

Even when out-of-order data is received from the server 120 in a proxy system including a multi-access connection, the proxy device 100 according to an embodiment of the present disclosure may convert only the header of the packet by utilizing a data forwarding table and then forward the data, thereby reducing overhead and enhancing the performance of the proxy device.

In addition, in a proxy system including a multi-access connection, the proxy device 100 according to an embodiment of the present disclosure may convert only the header of a packet by using a data forwarding table and then forward data by utilizing a SACK, thereby reducing overhead and enhancing the performance of the proxy device.

In addition, in a proxy system including a multi-access connection, the proxy device 100 according to an embodiment of the present disclosure may convert only the header of a packet by using a data forwarding table and then forward data by utilizing a NACK, thereby reducing overhead and enhancing the performance of the proxy device.

Referring to FIG. 9, the server 120 transmits data packet 5 810, data packet 6 820, data packet 7 830, and data packet 8 840, to the proxy device 100.

Due to various causes (e.g., network failure), among the data packets transmitted by the server 120, data packet 7 830 may not be received by the proxy device 100 or may be received with a delay.

In this case, data packet 7 830 corresponds to a data packet 910 that has not been received from the server 120, and data packet 8 840 corresponds to an out-of-order data packet.

Thereafter, the proxy device 100 performs operations S710 to S750 for data packet 5 810, data packet 6 820, and data packet 8 840.

In the data forwarding table 800, the proxy device 100 merges (920) server data sequence numbers 2000 to 3000 included in sequence identification information of data packet 7 830, and server data sequence numbers 3000-4000 included in sequence identification information of data packet 8 840.

Based on information configured in the application layer, the proxy device 100 maps the merged server data sequence numbers 2000 to 4000 (920) to subflow id 0 and subflow sequence numbers 1000 to 3000. The proxy device 100 stores information about a mapping relationship of the merged server data sequence numbers 2000 to 4000 (920), in entry 3 in the data forwarding table 800.

The proxy device 100 receives, from the client 110, ACKs for data packet 5 810 and data packet 6 820, and in this case, the proxy device 100 performs operations S760 to S790.

The proxy device 100 receives, from the client 110, a sack for data packet 8 840, which is an out-of-order packet.

The proxy device 100 reads the header of the SACK to obtain subflow SACK identification information including the merged client data sequence numbers 2000 to 4000 (920) in which client data sequence numbers 3000 to 4000 of data packet 8 840 are included.

The proxy device 100 searches the previously stored data forwarding table 800 to obtain ACK number identification information including server data sequence numbers 2000 to 4000 corresponding to the merged client data sequence number 2000 to 4000 (920) in entry 3.

The proxy device 100 generates a SACK consisting of a header including the ACK number identification information including server data sequence numbers 2000 to 4000, and the payload of the SACK, and transmits the SACK to the server 120. At this time, the proxy device 100 generates the SACK by including, in the header of an ACK, information indicating that the packet is an out-of-order data packet.

In an embodiment, the proxy device 100 may receive, from the client 110, a NACK for a data packet that has not been received by the client 110. A NACK may typically be in a separate TCP packet format. A NACK may be referred to as a NAK and may refer to a signal that may be used to confirm the arrival of a packet in a TCP connection. The header of the NACK may include subflow identification information about the data packet that has not been received by the client 110, and the payload of the NACK may include information indicating that a particular data packet has not been successfully received by the client 110.

The proxy device 100 may perform forwarding to the server 120 after converting only the header of the NACK. The server 120 that has received the NACK may retransmit, to the proxy device 100, the data packet that has not been received by the client 110. The proxy device 100 may forward the re-received data packet to the client 110 after converting only the header according to operations S701 to S705.

Referring to FIG. 9,
the proxy device 100 receives, from the client 110, a NACK for data packet 7 830, i.e., the packet 910 that has not been received from the server 120, and forwards the NACK to the server 120. The proxy device 100 may forward, to the server 120, the NACK received from the client 110 after modifying the header, and the detailed operations for this process may correspond to the method of forwarding an ACK described above with reference to FIG. 8. The NACK includes server data sequence numbers 2000 to 3000 of data packet 7 830. The server 120 that has received the NACK may retransmit data packet 7 830 to the proxy device 100.

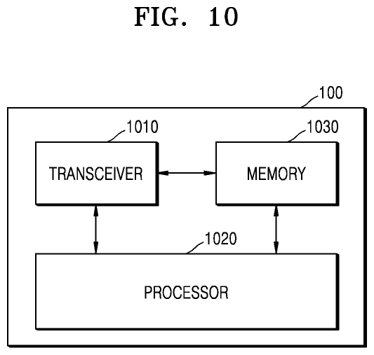

FIG. 10 is a block diagram of a proxy device according to an embodiment.

Referring to FIG. 10, the proxy device 100 may include a transceiver 1010, a processor 1020, and a memory 1030. The transceiver 1010, the processor 1020, and the memory 1030 of the proxy device 100 may operate according to the communication method of the proxy device 100 described above. However, the components of the proxy device 100 are not limited to the above-described example. For example, the proxy device 100 may include more or fewer components than the above-described components. In an embodiment, the transceiver 1010, the processor 1020, and the memory 1030 may be implemented as a single chip. In addition, the processor 1020 may include one or more processors.

The transceiver 1010 refers to both a receiving unit and a transmitting unit of the proxy device 100, and may transmit and receive signals to and from a client or a server. The signals transmitted and received to and from the client or server may include control information and data. To this end, the transceiver 1010 may include an RF transmitter that up-converts and amplifies the frequency of a signal being transmitted, and an RF receiver that performs low-noise amplification and down-converts the frequency of a received signal. However, this is merely an embodiment of the transceiver 1010, and the components of the transceiver 1010 are not limited to the RF transmitter and the RF receiver.

In addition, the transceiver 1010 may perform functions for transmitting and receiving signals through a radio channel. For example, the transceiver 1010 may receive a signal through a radio channel and output the received signal to the processor 1020, and may transmit a signal output from the processor 1020 through a radio channel.

The memory 1030 may store programs and data required for the operation of the proxy device 100. In addition, the memory 1030 may store control information or data included in a signal obtained by the proxy device 100. The memory 1030 may include any or a combination of storage media such as read-only memory (ROM), random-access memory (RAM), a hard disk, a compact disc (CD)-ROM (CD-ROM), or a digital video disc (DVD). In addition, the memory 1030 may not be a separate component but may be included in the processor 1020. The memory 1030 may include a volatile memory, a nonvolatile memory, or a combination of a volatile memory and a nonvolatile memory. In addition, the memory 1030 may provide data stored therein upon a request from the processor 1020.

The processor 1020 may control a series of operations to allow the proxy device 100 to operate according to the above-described embodiments of the present disclosure. For example, the processor 1020 may receive a control signal and a data signal through the transceiver 1010 and process the received control signal and data signal. The processor 1020 may transmit the processed control signal and data signal through the transceiver 1010. In addition, the processor 1020 may write or read data to or from the memory 1030. The processor 1020 may perform functions of a protocol stack required by a communication standard. To this end, the processor 1020 may include at least one processor or microprocessor. In an embodiment, the processor 1020 or a part of the transceiver 1010 may be referred to as a communication processor (CP).

The processor 1020 may include one or more processors. In this case, the one or more processors may be a general-purpose processor, such as a central processing unit (CPU), an application processor (AP), or a digital signal processor (DSP), a dedicated graphics processor such as a graphics processing unit (GPU) or a vision processing unit (VPU), or a dedicated artificial intelligence processor such as a neural processing unit (NPU). For example, in a case in which the one or more processors are dedicated artificial intelligence processors, the dedicated artificial intelligence processor may be designed with a hardware structure specialized for processing a particular artificial intelligence model.

Functions related to artificial intelligence according to the disclosure are performed by a processor and a memory. The processor may include one or more processors. In this case, the one or more processors may be a general-purpose processor, such as a CPU, an AP, or a DSP, a dedicated graphics processor such as a GPU or a VPU, or a dedicated artificial intelligence processor such as an NPU. The one or more processors perform control to process input data according to predefined operation rules or an artificial intelligence model stored in the memory. In a case where the one or more processors are dedicated artificial intelligence processors, the dedicated artificial intelligence processor may be designed with a hardware structure specialized for processing a particular artificial intelligence model.

A detailed example for describing an embodiment according to the present disclosure is only a combination of each standard, method, detailed method, and operation, and the proxy device may perform data forwarding between a client and a server through a combination of at least two of various techniques described above. In addition, here, the data forwarding may be performed according to a method determined through one or a combination of two or more of the above-described techniques regarding conversion of the header of a data packet. For example, it may be possible to perform some of operations of an embodiment in combination with some of operations of another embodiment.

A machine-readable storage medium may be provided in the form of a non-transitory storage medium. Here, the term ‘non-transitory storage medium’ refers to a tangible device and does not include a signal (e.g., an electromagnetic wave), and the term ‘non-transitory storage medium’ does not distinguish between a case where data is stored in a storage medium semi-permanently and a case where data is stored temporarily. For example, the ‘non-transitory storage medium’ may include a buffer in which data is temporarily stored.

According to an embodiment, methods according to various embodiments disclosed herein may be included in a computer program product and then provided. The computer program product may be traded as commodities between sellers and buyers. The computer program product may be distributed in the form of a machine-readable storage medium (e.g., a CD-ROM), or may be distributed online (e.g., downloaded or uploaded) through an application store or directly between two user devices (e.g., smart phones). In a case of online distribution, at least a portion of the computer program product (e.g., a downloadable app) may be temporarily stored in a machine-readable storage medium such as a manufacturer's server, an application store's server, or a memory of a relay server.

1. A method, performed by a proxy device, of supporting a multi-access connection, the method comprising:
generating a first connection between a client and the proxy device, and a second connection between the proxy device and a server;
receiving first data packets from the client via at least one subflow constituting the first connection;
obtaining, based on at least one piece of subflow identification information included in a header of the received first data packets, at least one piece of sequence identification information corresponding to the at least one piece of subflow identification information;
generating a second data packet consisting of a header including the at least one piece of sequence identification information, and a payload of the first data packets; and
transmitting the second data packet to the server via the second connection.

2. The method of claim 1, further comprising storing, in a data forwarding table, information on a mapping relationship between the at least one piece of subflow identification information and the at least one piece of sequence identification information.

3. The method of claim 2, further comprising:
receiving, from the server via the second connection, a first acknowledgment (ACK) for the second data packet;
obtaining, based on at least one piece of ACK identification information included in a header of the received first ACK, at least one piece of subflow ACK identification information corresponding to the at least one piece of ACK identification information, from the data forwarding table;
generating a second ACK consisting of a header including the at least one piece of subflow ACK identification information, and a payload of the first ACK; and
transmitting the second ACK to the client via the at least one subflow constituting the first connection.

4. The method of claim 3, further comprising:
in case of there being a data packet for which the second ACK has not been received among the first data packets,
receiving, from the client via the at least one subflow constituting the first connection, the data packet for which the second ACK has not been received; and
obtaining, based on at least one piece of subflow identification information included in a header of the received data packet, at least one piece of sequence identification information corresponding to the at least one piece of subflow identification information, from the data forwarding table.

5. The method of claim 2, wherein the storing in the data forwarding table comprises, in case of an out-of-order data packet being included among data packets received from the client, maintaining an entry corresponding to the out-of-order data packet in the data forwarding table, and setting, as a blank space, an entry corresponding to a data packet that has not been received from the client.

6. The method of claim 5, further comprising:
receiving, from the server via the second connection, a first selective ACK (SACK) including information on the out-of-order data packet;
obtaining, based on at least one piece of SACK identification information included in a header of the received first SACK, at least one piece of subflow SACK identification information corresponding to the at least one piece of SACK identification information, from the data forwarding table;
generating a second SACK consisting of a header including the at least one piece of subflow SACK identification information corresponding to the at least one piece of SACK identification information, and a payload of the first SACK; and
transmitting the second SACK to the client via the at least one subflow constituting the first connection.

7. The method of claim 1, wherein the first connection and the second connection constitute a single abstract connection, and
the single abstract connection is configured by using a proxy socket configured for the single abstract connection, in an application layer of the proxy device.

8. A method, performed by a proxy device, of supporting a multi-access connection, the method comprising:
generating a first connection between a client and the proxy device, and a second connection between the proxy device and a server;
receiving a third data packet from the server via the second connection;
obtaining, based on at least one piece of sequence identification information included in a header of the received third data packet, at least one piece of subflow identification information corresponding to the at least one piece of sequence identification information;
generating a fourth data packet consisting of a header including the at least one piece of subflow identification information, and a payload of the third data packet; and
transmitting the fourth data packet to the client via at least one subflow constituting the first connection.

9. The method of claim 8, further comprising storing, in a data forwarding table, information on a mapping relationship between the at least one piece of sequence identification information and the at least one piece of subflow identification information,
wherein the storing in the data forwarding table comprises:
in case of an out-of-order data packet being included among data packets received from the server, merging sequence identification information included in a header of the out-of-order data packet, and sequence identification information corresponding to a data packet that has not been received from the server, into one piece of sequence identification information; and
setting the merged one piece of sequence identification information as one entry.

10. A proxy device for supporting a multi-access connection, the proxy device comprising a transceiver, a memory, and at least one processor,
wherein the at least one processor is configured to generate a first connection between a client and the proxy device, and a second connection between the proxy device and a server, receive first data packets from the client via at least one subflow constituting the first connection, obtain, based on at least one piece of subflow identification information included in a header of the received first data packets, at least one piece of sequence identification information corresponding to the at least one piece of subflow identification information, generate a second data packet consisting of a header including the at least one piece of sequence identification information, and a payload of the first data packets, and transmit the second data packet to the server via the second connection.

11. The proxy device of claim 10, wherein the at least one processor is further configured to store, in a data forwarding table, information on a mapping relationship between the at least one piece of subflow identification information and the at least one piece of sequence identification information.

12. The proxy device of claim 11, wherein the at least one processor is further configured to receive, from the server via the second connection, a first acknowledgment (ACK) for the second data packet, obtain, based on at least one piece of ACK identification information included in a header of the received first ACK, at least one piece of subflow ACK identification information corresponding to the at least one piece of ACK identification information, from the data forwarding table, generate a second ACK consisting of a header including the at least one piece of subflow ACK identification information, and a payload of the first ACK, and transmit the second ACK to the client via the at least one subflow constituting the first connection.

13. The proxy device of claim 12, wherein the at least one processor is further configured to, in case of there being a data packet for which the second ACK has not been received among the first data packets, receive, from the client via the at least one subflow constituting the first connection, the data packet for which the second ACK has not been received, and obtain, based on at least one piece of subflow identification information included in a header of the received data packet, at least one piece of sequence identification information corresponding to the at least one piece of subflow identification information, from the data forwarding table.

14. The proxy device of claim 11, wherein the at least one processor is further configured to, in case of an out-of-order data packet being included among data packets received from the client, maintain an entry corresponding to the out-of-order data packet in the data forwarding table, and set, as a blank space, an entry corresponding to a data packet that has not been received from the client.

15. A computer-readable recording medium having recorded thereon at least one program for executing the method of claim 1.
